(19) United States
(12) Patent Application Publication
(10) Pub. No.: US 2025/0141995 A1
(43) Pub. Date: May 1, 2025

(54) MOBILE DEVICE CONTACT CUSTOMIZATION AND MANAGEMENT

(71) Applicant: Thinkspan, LLC, Highland Park, IL (US)

(72) Inventor: Brian Samuel Taylor, Highland Park, IL (US)

(21) Appl. No.: 18/930,161

(22) Filed: Oct. 29, 2024

Related U.S. Application Data
(60) Provisional application No. 63/594,314, filed on Oct. 30, 2023.

(51) Int. Cl. H04M 3/42; H04W 4/16

(52) U.S. Cl. CPC H04M 3/42153; H04W 4/16

(57) ABSTRACT

A server provide a mobile device with executable code that, when executed by the mobile device, creates or modifies a customized contact within the mobile device. A custom link can be created based on characteristics of the mobile device or a user of the mobile device, and the link can be included in the customized contact. The custom link, when selected, causes the mobile device and/or the server to perform an action specific to the user or the mobile device. For instance, the custom link can initiate an authentication process, can generate message content, can initiate a messaging session, and can navigate the mobile device to a page specific to the user or the mobile device.

### CROSS REFERENCE TO RELATED APPLICATIONS

This application claims the benefit of U.S. Provisional Application No. 63/594,314, filed Oct. 30, 2023, which is incorporated by reference in its entirety.

### BACKGROUND

A contact list stored on an electronic device is a collection of names representing an entity such as an individual or an organization. The contact list contains, in addition to names, contact information of the individuals or organizations such as phone numbers, addresses, or emails. To communicate with someone on the list, a user can select a name and act upon it, for example, open a new email editing session or telephone call. The information contained in the contact list is particular to the individual or organization and is not influenced by the electronic device storing the contact information.

### BRIEF DESCRIPTION OF THE DRAWINGS

Detailed descriptions of implementations of the present invention will be described and explained through the use of the accompanying drawings.

FIG. 1 shows an overview of a system for generating a custom contact, according to some embodiments.

FIG. 2 shows the custom contact stored on the electronic device, according to some embodiments.

FIG. 3 shows multifactor authentication of the electronic device, according to some embodiments.

FIG. 4A is a flowchart illustrating a process to create and use a custom contact to authenticate a device, according to some embodiments.

FIG. 4B is a flowchart illustrating a process of a method to create and use a custom contact to perform an action associated with a device, according to some embodiments.

FIG. 5 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

Disclosed here is a system and method to create and use a custom contact. Based on an interaction between an electronic device and a server, such as a server associated with an organization, company, or other entity, the system may obtain a unique identifier associated with an electronic device and information associated with a user of the electronic device. The server can generate a set of executable code and can provide the executable code to the electronic device. The code, when executed, can create a custom contact to be included in a list of contacts stored on the electronic device. The custom contact includes a custom link personalized to the user of the electronic device or to the electronic device itself, which can include contact information associated with the entity. The custom link can be stored within the custom contact and can, when selected, cause the electronic device or the server to perform an action associated with the user, the electronic device, the server, or the entity. One or more of the unique identifier associated with the electronic device, information associated with the user of the electronic device, and the custom link can be stored within a database associated with the organization.

In some embodiments, the custom contact can be sent to the electronic device. In such embodiments, the custom link may be included within the custom contact, or can subsequently be provided to the electronic device for inclusion in the custom contact. In some embodiments, upon receiving the selection of the custom link, the electronic device can be authenticated by sending a message to the electronic device (for instance, using the unique identifier), and the message can include a secret code. Upon receiving the secret code, the electronic device can be authenticated and access can be granted to the user and/or the electronic device.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail to avoid unnecessarily obscuring the descriptions of examples.

### Creating and Using a Custom Contact

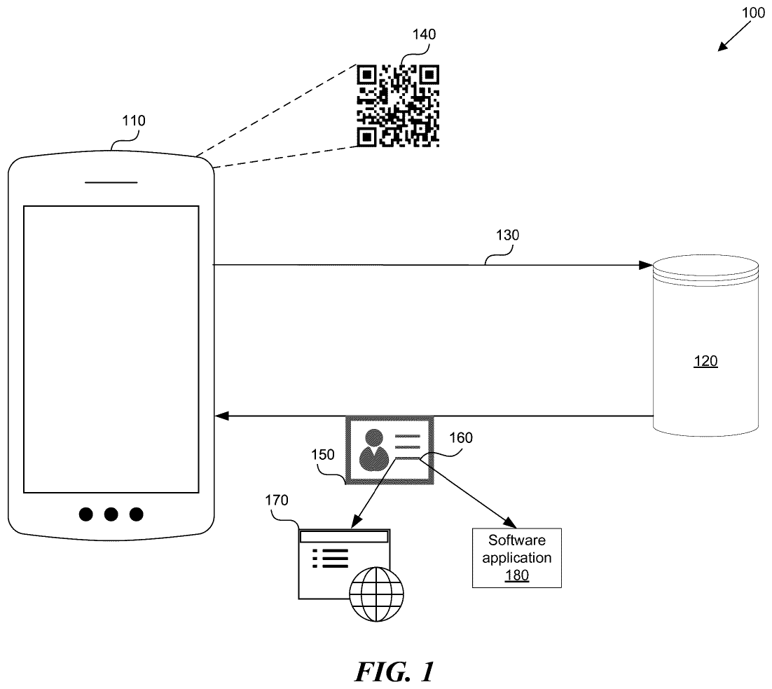

FIG. 1 shows an overview of the system 100 for generating a custom contact, according to some embodiments. An electronic device 110 can interact with a database 120 belonging to an organization or entity such as a school, a pizzeria, a pet grooming business, an appliance seller, etc. The electronic device 110 can be a phone, a wearable device, a laptop, a desktop, a personal digital assistant, a mobile device, or any other suitable device. The interaction 130 can be initiated in various ways such as, for example, scanning the Quick Response (QR) code 140 associated with the organization using the database 120. For example, the QR code 140 can be attached to a product produced by the business. Additionally, the interaction 130 can include visiting a place of business, visiting a business's website, signing up for information about the entity, selecting a “create contact” link or button on a webpage associated with the entity, using an application associated with the entity, or creating an account in the database 120.

Based on the interaction 130, the system 100 can send the custom contact 150 to the electronic device 110. In some embodiments, the custom contact 150 can include executable code or a script that when executed, creates or modifies a contact within the electronic device 110. Such code can be generated by the system 100, for instance in response to detecting the interaction 130. In some embodiments, the custom contact 150 can include a API call to a “create contact” interface associated with an address book or another application running on the electronic device 110. In other embodiments, the custom contact 150 can include sending a link (for instance, via SMS or an application running on the electronic device 110) that when selected, initiates the contact creation or modification process.

The custom contact 150 can include a custom link 160 that is particular to the electronic device 110. The custom link 160 can require the electronic device 110 to authenticate itself prior to gaining access to the information to which the custom link 160 points. The custom link 160 can lead to a web page 170 that is customized for the electronic device 110 or to a software application 180 also customized for the electronic device, as explained in this disclosure. The custom link 160 can be secret and not shared with any other electronic devices.

In some embodiments, the custom link 160 is generated in advance of the creation of a contact by the electronic device, and in such embodiments, the custom link can be included within the custom contact at the point the custom contact is create (or an existing contact is modified). In some embodiments, the custom link 160 is generated in conjunction with the creation or modification of a contact, for instance in response to and/or based on receiving an identifier associated with the electronic device 110 or a user of the electronic device (e.g., a portion of the custom link 160 unique to the user and/or mobile device can be generated based on the unique identifier, for instance by performing a hash operation on a value of the unique identifier and include the hash output within the custom link). In some embodiments, the custom link 160 is generated after the custom contact is created or modified, and the custom contact is subsequently modified to include the custom link.

For example, the interaction 130 can include receiving a text from the organization after the electronic device has physically visited the organization (for instance, determined using GPS information from the electronic device) or has visited the organization's web page (for instance, using one or more tracking cookies). The text can require a user of the electronic device 110 to create an account associated with the database 120. The account can include a unique identifier associated with the electronic device 110, a password, and/or a username. Upon creating the account, the system 100 can send the custom contact 150 to the electronic device 110. The unique identifier associated with the electronic device 110 can include a phone number associated with the electronic device, a subscriber identity module (SIM) number associated with the electronic device, an International Mobile Subscriber Identity (IMSI), a Mobile Subscriber ISDN Number (MSISDN), a username, or any other information that uniquely identifies either the user or the electronic device 110. The database 120 may store the unique identifier associated with the electronic device 110 and the custom link 160 to use in authentication of the electronic device as explained in this disclosure below.

The custom link 160, in response to being selected from within an interface displaying the custom contact 150, can configure the electronic device 110 and/or a server associated with an entity to perform an action specific to the user or the electronic device. Examples include but are not limited to: initiating an authentication process of a user of the electronic device, establishing a messaging session with the one or more servers associated with the entity, generating message content associated with the entity, navigating the electronic device to a portal associated with the user and the entity, and navigating the electronic device to a custom page associated with the user and the entity. In some embodiments, in addition to including the custom link within the custom contact, text describing the action associated with the custom link can be generated and included within the custom contact in association with the custom link. For instance, if the action performed by a custom link includes generating an email shell, the custom contact can be modified to include the text “Generate email template”, near or in association with the custom link.

In another example, the database 120 can include authentication information associated with the electronic device 110, such as a unique identifier associated with the electronic device 110, a password, and/or a username. The system 100 can analyze the database 120 to generate the custom contact 150 including the custom link 160. In addition, the system can generate a web page 170 to which the custom link 160 leads. The web page 170 can include information from the database 120 or other databases associated with the entity.

In a more specific example, the entity can sell a product that the user purchased. The user can scan the QR code 140 on a recently purchased product and can receive a request to create an account in the database 120. Upon creating an account in the database 120, the system 100 can generate a customized web page 170 which provides the product information, maintenance requirements, service providers, warranty, etc. The customized web page 170 can also include information about other products that the user purchased from the same provider. In some embodiments, the custom link 160 can link the user to a user account page associated with an entity or a customized page populated with content specific to the user or the electronic device, enabling the user to navigate to such a page with a single click.

In another example, the custom link 160 can lead the user to the software application 180. If the software application 180 is not installed in the electronic device, the custom link 160 can ask the user to install the software application. The software application can be any suitable application associated with the user or the entity, and the electronic device 110 can launch the application directly from an interface displaying the custom contact 150 without requiring the user or the electronic device to select an icon associated with the application.

The database 120 can be a zero-knowledge database as described in U.S. patent application Ser. No. 15/996,268, now issued as U.S. Pat. No. 10,949,502B2, incorporated herein by reference in its entirety. The database 120 can store personal information, for instance including medical records or psychologist's notes. The custom link 160 can connect the user to a doctor's or psychologist's website and enable the user to upload a personal diary to the database 120.

In some embodiments, an entity (such as a company or organization) can generate and send executable code to all users associated with the entity (such as customers or members of an organization), enabling each user to create a custom contact associated with the entity with custom links corresponding to actions associated with the entity. In some embodiments, an entity can create custom contacts, for instance one for each of a set of users, and can send the custom contacts to the set of users.

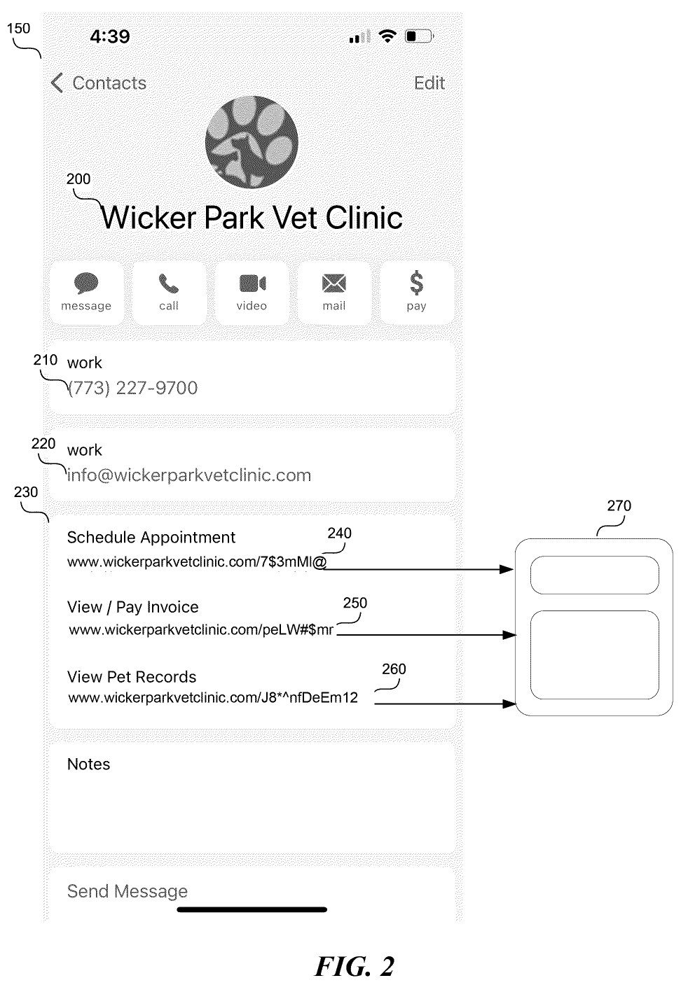

FIG. 2 shows the custom contact 150 stored on the electronic device 110 in FIG. 1, according to some embodiments. The custom contact 150 can be stored in the contacts associated with the electronic device 110, for instance within a native address book application or within any other suitable application, address book, or contact database associated with the electronic device. The custom contact 150, in addition to having information about the entity such as the name 200, the phone number 210, and email address 220, also has information 230 customized to the electronic device 110. The custom information 230 can include customized links to schedule an appointment with a custom link 240, to view or pay an invoice with a custom link 250, or view pet records with a custom link 260. In one embodiment, the phone number 210 can be customized to the electronic device 110.

By selecting one of the links 240, 250, 260, the user can access a custom site 270, such as a web page or a custom application that presents information relevant to the user. The links 240, 250, 260 and the custom site 270 are unique to the user, and not accessible to other users of the system. It should be noted that FIG. 2 illustrates the inclusion of multiple custom links, each specific to the electronic device or a user of the electronic device, within a custom contact and each associated with a different action to be performed in response to a selection of the custom link. In practice, any number of custom links, each associated with a different action, can be included within a custom contact.

In one example, the custom site 270 can be a web page or a software application enabling the user to schedule appointments with the entity, including a doctor, veterinarian, hairstylist, a lawyer, etc. In such embodiments, selecting a custom link can initiate a communication session with the entity, enabling the electronic device to schedule the appointment on behalf of the user. It should also be noted that in some embodiments, in the event that a user other than the user associated with the electronic device selects a custom link, or if a different device selects the custom link, the action associated with the custom link may not be performed, thus beneficially ensuring that only the user or the electronic device (or both) can perform the action associated with the custom link by selecting the custom link.

In another example, the custom site 270 can be a web page or a software application allowing the user to pay the user's invoice, such as an invoice from an educational institution, a service provider, a product provider, etc. If the custom site 270 enables payment, the custom site 270 can provide the outstanding balance and other invoices that the user may have with the organization.

In a third example, the custom site 270 can be a web page or software application that enables the user to view the user's private information stored in the database 120 or another database associated with the organization. The user's private information can be purchase history associated with the user, medical records of the user or the user's pet, maintenance information associated with products the user owns, history of interaction between the user and the organization, etc.

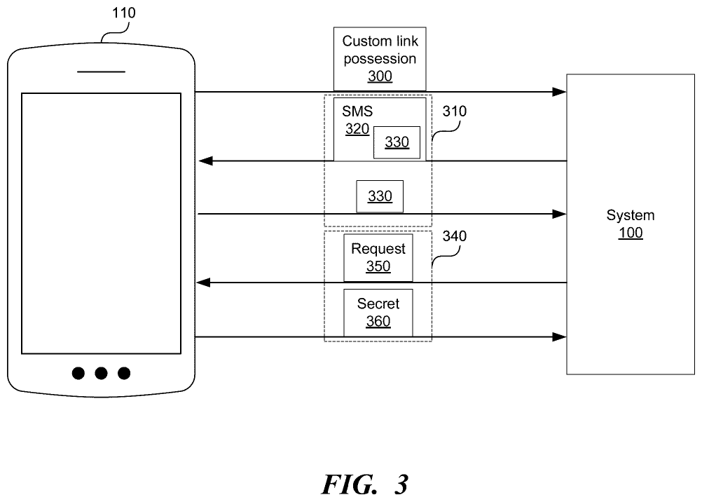

FIG. 3 shows multifactor authentication of the electronic device 110, according to some embodiments. When the user selects one of the custom links 240, 250, 260 in FIG. 2, the system 100 may authenticate the user and/or the electronic device 110 without further action by the user or the electronic device because the custom link 240, 250, 260 leads to web page 170 in FIG. 1 or a software application 180 in FIG. 1 includes information that is unique to and that identifies the user.

In some embodiments, the system 100 can employ multifactor authentication to grant access to the web page 170 and/or the software application 180. The first factor in the multifactor authentication can be the custom link possession 300 of the custom links 240, 250, 260. In other words, the custom links 240, 250, 260 are not shared with any other user associated with the system 100. To verify the custom link possession 300 as the first factor 300, the system 100 verifies that a request to access the custom link 240, 250, or 260 is received (e.g., a custom link has been displayed to a user of the electronic device 110 and selected by the user).

The second factor 310 in the multifactor authentication system can be the possession of the electronic device 110. To verify the possession of the electronic device 110, the system can send a message 320, e.g. an automatic Short Message Service (SMS) message, with a secret code 330 to the unique identifier stored in the database 120 and associated with the electronic device 110, and the custom links 240, 250, 260. If the electronic device 110 receives the secret code, the electronic device can provide the secret code 330 contained in the SMS message 320 to the system 100. Consequently, upon receiving the secret code 330, the system 100 can determine that the second factor 310, namely the possession of the electronic device, is satisfied.

The code 330 can be manually entered by a user of the electronic device 110 into a field displayed by the web page 170 or application 180, or can be automatically entered into the field (for instance, in response to a selection of an interface element displayed by the web page 170 or application 180 by a user). In some embodiments, the electronic device 110 can, in response to receiving the code 330, automatically enter the code 330 within a field of the web page 170 or application 180, and can automatically submit the code to the system 100. In such embodiments, the electronic device 110 can be authenticated using 2-factor authentication with only two inputs from a user (the first input including the selection of the link 240, 250, or 260 and the second input including the submission of the secret code 330 within a field of the web page 170 or application 180). In some embodiments, the electronic device 110 can be authenticated using 2-factor authentication with only one input from a user (the selection of the link 240, 250, or 260), where the code 330 is received and automatically entered and submitted within a field of the web page 170 or application 180 without additional user input.

In some embodiments, the multifactor authentication system can include a third factor 340, such as knowledge of a secret 360 or password. The system 100 can send a request 350 to the electronic device 110 to provide the secret 360 associated with the custom link 240, 250, 260 and store the database 120 in FIG. 1. In response to the request 350, the electronic device 110 can provide the requested secret 360. If the system verifies that the provided secret 360 matches the secret stored in the database 120 and associated with the custom link 240, 250, 260, the system can determine that the third factor 340 is satisfied. The system 100 can rely mostly on the first two factors 300, 310, and avoid use of the third factor 340 for ease of use.

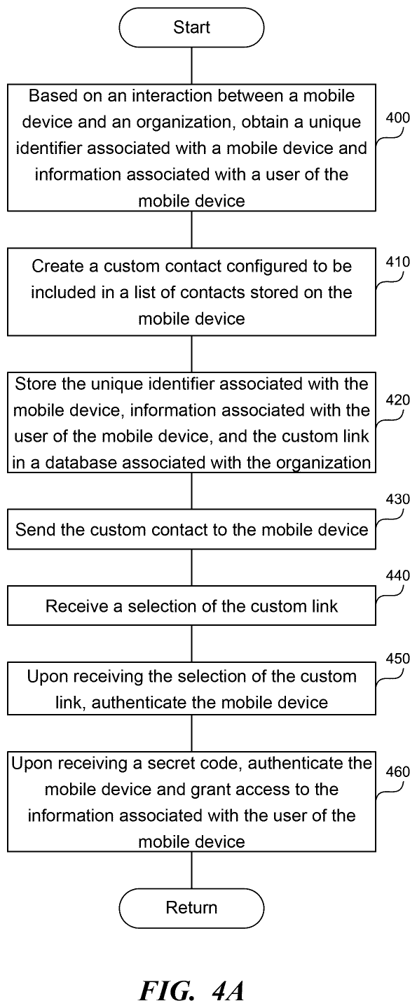

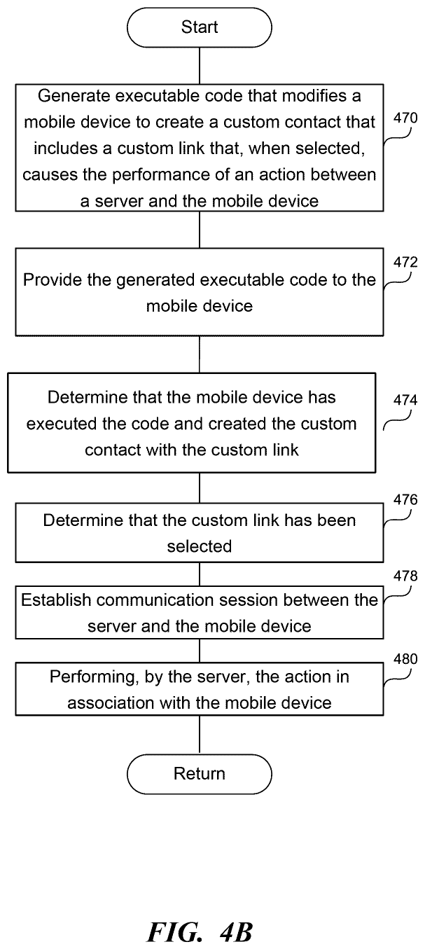

FIG. 4A is a flowchart illustrating a process to create and use a custom contact to authenticate a device, according to some embodiments. In other embodiments, the process can include fewer, additional, or different steps than those described herein.

A hardware or software processor executing instructions described in this disclosure can obtain 400, based on the interaction between an electronic device and an organization, a unique identifier associated with an electronic device and information associated with a user of the electronic device.

The processor can create 410 a custom contact configured to be included in a list of contacts stored on the electronic device, where the custom contact includes a custom link personalized to the user of the electronic device and contact information associated with the organization.

The processor can store 420 the unique identifier associated with the electronic device, information associated with the user of the electronic device, and the custom link in a database associated with the organization.

The processor can send 430 the custom contact to the electronic device. In step 440, the processor can receive a selection of the custom link.

To make the custom link accessible, e.g. usable, the processor can authenticate 450 the electronic device. Upon receiving the selection of the custom link, the processor can authenticate the electronic device by sending a message to the unique identifier associated with the electronic device, where the message includes a secret code.

Upon receiving the secret code, the processor can authenticate 460 the electronic device and grant access to the information associated with the user of the electronic device.

FIG. 4B is a flowchart illustrating a process of a method to create and use a custom contact to perform an action associated with a device, according to some embodiments. In other embodiments, the process can include fewer, additional, or different steps than those described herein.

A set of executable code can be generated 470, for instance in response to a request for a custom contact by a mobile device, or in response to an action performed by the mobile device or a user of the mobile device. The set of executable code can modify 470 the mobile device by creating or modifying a custom contact for storage by the mobile device. The custom contact can include a custom link that, when selected, causes the performance of an action between a server and the mobile device. The custom link can be generated in response to the request for a custom contact, in advance of the generation of the executable code, or upon the execution of the executable code by the mobile device.

The generated executable code is provided 472 to the mobile device. After it is determined 474 that the mobile device has executed the code, that the custom contact is created, and that the custom link is included within the custom contact, it can be determined 476 that the custom link has been selected. For instance, a user can view the custom contact within an interface displayed by the mobile device, and can select the custom link displayed within the displayed custom contact.

In response to the selection of the custom link, a communication session is established 478 between the server and the mobile device. Using the communication session, the action 480 associated with the custom link can be performed 480 by the server in association with the mobile device. For instance, the mobile device can be navigated to a web page customized to a user of the mobile device, or a chat session can be established between the user and an entity associated with the server.

### Computer System

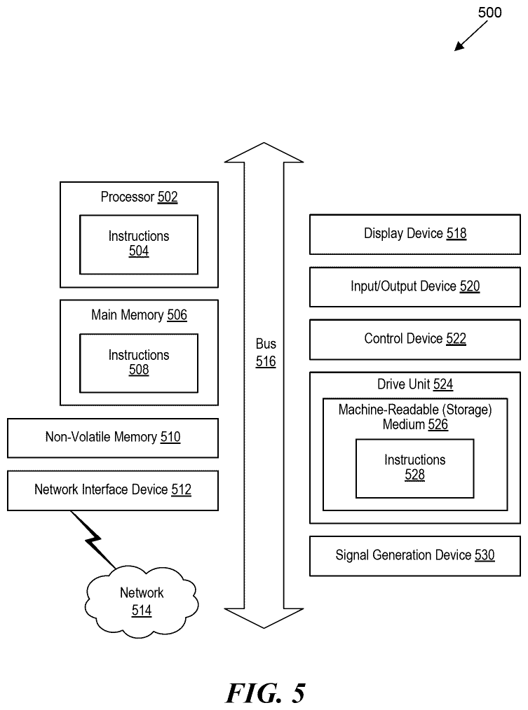

FIG. 5 is a block diagram that illustrates an example of a computer system 500 in which at least some operations described herein can be implemented. As shown, the computer system 500 can include: one or more processors 502, main memory 506, non-volatile memory 510, a network interface device 512, a video display device 518, an input/output device 520, a control device 522 (e.g., keyboard and pointing device), a drive unit 524 that includes a machine-readable (storage) medium 526, and a signal generation device 530 that are communicatively connected to a bus 516. The bus 516 represents one or more physical buses and/or point-to-point connections that are connected by appropriate bridges, adapters, or controllers. Various common components (e.g., cache memory) are omitted from FIG. 5 for brevity. Instead, the computer system 500 is intended to illustrate a hardware device on which components illustrated or described relative to the examples of the Figures and any other components described in this specification can be implemented.

The computer system 500 can take any suitable physical form. For example, the computing system 500 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 500. In some implementations, the computer system 500 can be an embedded computer system, a system-on-chip (SOC), a single-board computer system (SBC), or a distributed system such as a mesh of computer systems, or it can include one or more cloud components in one or more networks. Where appropriate, one or more computer systems 500 can perform operations in real time, in near real time, or in batch mode.

The network interface device 512 enables the computing system 500 to mediate data in a network 514 with an entity that is external to the computing system 500 through any communication protocol supported by the computing system 500 and the external entity. Examples of the network interface device 512 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 506, non-volatile memory 510, machine-readable medium 526) can be local, remote, or distributed. Although shown as a single medium, the machine-readable medium 526 can include multiple media (e.g., a centralized/distributed database and/or associated caches and servers) that store one or more sets of instructions 528. The machine-readable medium 526 can include any medium that is capable of storing, encoding, or carrying a set of instructions for execution by the computing system 500. The machine-readable medium 526 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a programmed product in a variety of forms. Examples of machine-readable storage media, machine-readable media, or computer-readable media include recordable-type media such as volatile and non-volatile memory 510, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 504, 508, 528) set at various times in various memory and storage devices in computing device(s). When read and executed by the processor 502, the instruction(s) cause the computing system 500 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A method comprising:
generating, in response to a request by a mobile device received by a server of a entity, a set of executable code that, when executed:
modifies a mobile device to include a contact within the mobile device;
generates a custom link specific to a user of the mobile device that, when selected, configures the mobile device to perform an action in association with one or more servers associated with the entity; and
modifies the contact to include the generated custom link in association with text describing the action;
providing the generated set of executable code to the mobile device; and
in response to a selection of the custom link by the mobile device after the mobile device has executed the set of executable code:
establishing, by the one or more servers associated with the entity, a communication session with the mobile device; and
performing, by the one or more servers associated with the entity, the action in association with the mobile device.

2. The method of claim 1, wherein the request by the mobile device includes a unique identifier associated with the mobile device or the user of the mobile device, and wherein the set of executable code is generated based at least in part on the unique identifier.

3. The method of claim 2, wherein the custom link is generated based at least in part on the unique identifier.

4. The method of claim 1, wherein the custom link, when selected by a user other than the user of the mobile device or by a device other than the mobile device, does not cause the action to be performed.

5. The method of claim 1, wherein the set of executable code, in response to execution by the mobile device, modifies the mobile device to include the contact within a native address book within the mobile device.

6. The method of claim 5, wherein the set of executable code, in response to execution by the mobile device, uses a native address book API within an operating system of the mobile device to include the contact within the native address book.

7. The method of claim 1, wherein the action includes one or more of: initiating an authentication process of a user of the mobile device, establishing a messaging session with the one or more servers associated with the entity, generating message content associated with the entity, navigating the mobile device to a portal associated with the user and the entity, and navigating the mobile device to a custom page associated with the user and the entity.

8. A method comprising:
requesting, by the mobile device from a server associated with an entity, a set of executable code, the set of executable code associated with a creation of a contact of the mobile device;
executing, by the mobile device, the set of executable code, the executable code configured to modify the mobile device to create the contact within the mobile device, to modify the contact to include a custom link specific to a user of the mobile device that, when selected, causes the mobile device to perform an action in association with one or more servers associated with the entity, and to further modify the contact to include text describing the action;
displaying, by the mobile device, the contact within an interface of the mobile device;
receiving, by the mobile device, a selection of the custom link within the interface;
in response to the selection of the custom link, establishing, by the mobile device, a communication session with the one or more servers associated with the entity; and
performing, by the mobile device in association with the one or more servers associated with the entity, the action associated with the custom link.

9. The method of claim 8, wherein the request by the mobile device includes a unique identifier associated with the mobile device or the user of the mobile device, and wherein the set of executable code is generated based at least in part on the unique identifier.

10. The method of claim 9, wherein the custom link is generated based at least in part on the unique identifier.

11. The method of claim 8, wherein the custom link, when selected by a user other than the user of the mobile device or by a device other than the mobile device, does not cause the action to be performed.

12. The method of claim 8, wherein the set of executable code, in response to execution by the mobile device, modifies the mobile device to include the contact within a native address book within the mobile device.

13. The method of claim 12, wherein the set of executable code, in response to execution by the mobile device, uses a native address book API within an operating system of the mobile device to include the contact within the native address book.

14. The method of claim 8, wherein the action includes one or more of: initiating an authentication process of a user of the mobile device, establishing a messaging session with the one or more servers associated with the entity, generating message content associated with the entity, navigating the mobile device to a portal associated with the user and the entity, and navigating the mobile device to a custom page associated with the user and the entity.

15. A non-transitory computer-readable storage medium storing executable instructions that, when executed by a server of an entity, cause the server to perform steps comprising:
generating, in response to a request by a mobile device received by the server of the entity, a set of executable code that, when executed:
modifies a mobile device to include a contact within the mobile device;
generates a custom link specific to a user of the mobile device that, when selected, configures the mobile device to perform an action in association with one or more servers associated with the entity; and
modifies the contact to include the generated custom link in association with text describing the action;
providing the generated set of executable code to the mobile device; and
in response to a selection of the custom link by the mobile device after the mobile device has executed the set of executable code:
establishing, by the one or more servers associated with the entity, a communication session with the mobile device; and
performing, by the one or more servers associated with the entity, the action in association with the mobile device.

16. The non-transitory computer-readable storage medium of claim 15, wherein the request by the mobile device includes a unique identifier associated with the mobile device or the user of the mobile device, and wherein the set of executable code is generated based at least in part on the unique identifier.

17. The non-transitory computer-readable storage medium of claim 16, wherein the custom link is generated based at least in part on the unique identifier.

18. The non-transitory computer-readable storage medium of claim 15, wherein the custom link, when selected by a user other than the user of the mobile device or by a device other than the mobile device, does not cause the action to be performed.

19. The non-transitory computer-readable storage medium of claim 15, wherein the set of executable code, in response to execution by the mobile device, modifies the mobile device to include the contact within a native address book within the mobile device.

20. The non-transitory computer-readable storage medium of claim 19, wherein the set of executable code, in response to execution by the mobile device, uses a native address book API within an operating system of the mobile device to include the contact within the native address book.
